(19) United States
(12) Patent Application Publication
(10) Pub. No.: US 2009/0271284 A1
(43) Pub. Date: Oct. 29, 2009

(54) Community based electronic bartering network

(76) Inventor: Stephen M. Arbib, (US)

Correspondence Address: Alex Porat, 445 Beverley Glen Blvd, Thornhill, ON, L4J 7S2, CA

(21) Appl. No.: 12/385,903

(22) Filed: Apr. 23, 2009

Related U.S. Application Data
(60) Provisional application No. 61/071,351, filed on Apr. 23, 2008.

(51) Int. Cl. G06Q 30/00; G06Q 10/00; G06Q 99/00

(52) U.S. Cl. 705/26; 705/30; 705/1

(57) ABSTRACT

An electronic bartering system which associates each user with at least one community and enables users to create their own communities. Each user can specify at least one barterable item in a wish list and at least one barterable item in a trade list. Within a given community, the system periodically compares the wish lists and trade lists only of users within the community in order to identify a trade match. When a match is identified, an e-mail message is sent to users advising of the trade match. The system also receives confirmation from the users accepting or rejecting the trade match.

This application claims priority to U.S. Provisional Application No. 61/071,351, entitled “Community Based Electronic Bartering Network”, filed Apr. 23, 2008.

### FIELD OF INVENTION

The invention relates generally to the field of electronic bartering networks.

### BACKGROUND OF INVENTION

Electronic bartering networks, where subscribers to an Internet service are able to trade items of interest with other subscribers, are known. Examples of such systems are described in Publication No. US2007/0124228 to Elias et al. and Publication No. US2006/0047594 to Haase. Web-based electronic bartering systems have also been commercially deployed. One example is the U-Exchange service accessible at www.U-exchange.com.

One of the problems with conventional electronic bartering services is that such systems typically list items available for trade amongst people that are essentially strangers to one another. For example, the U-Exchange™ bartering site contains a broad database of items or services available for trade from people located in many different geographical areas. This database is searchable so that items can be found based on a description of the item and/or geographical filters. However, the persons trading generally have no natural nexus between themselves, other than the mutual desire to exchange certain items or services.

The invention seeks to increase the probability and frequency of bartering by encouraging parties to interact socially.

### SUMMARY OF INVENTION

According to one aspect of the invention, an electronic bartering system is provided which associates each user with at least one community and enables users to create their own communities. Each user can specify at least one barterable item in a wish list and at least one barterable item in a trade list. Within a given community, the system periodically compares the wish lists and trade lists only of users within the community in order to identify a trade match. When a match is identified, an e-mail message is sent to users advising of the trade match. The system also receives confirmation from the users accepting or rejecting the trade match.

A two-way trade match is identified when an item on a first user's wish list appears on a second user's trade list and another item on the second user's wish list appears on the first user's trade list. The system preferably also recognizes a three-way trade match.

In the preferred embodiment, each community is associated with an electronic bulletin board visible to at least the members of the community. Each community is preferably designated as either a private or a public community. Each private community is associated with at least one moderator, and a user requires permission from at least one moderator of a private community prior to joining the private community. Public communities may be freely joined by any user. Moreover, preferably any user can create a new community and the originating user creating the community is the first moderator. And any community moderator can pass on moderator rights to any other member of the same community.

In the preferred embodiment, items are associated with a commercial standard product number and a suggested sales price or value. Preferably, a user can upload or send a photo or image of a product bar code to the system and have the system resolve the bar code to identify the corresponding item and enable the user to add it to his or her wish list or trade list. The system also preferably includes an accumulator for estimating the accumulated value of bartered items and wherein, upon acceptance of the trade match, the accumulator is updated. The system preferably maintains a global accumulator for estimating the value of all trades generated by the system, a community accumulator for estimating the value of all trades within a given community, and a personal accumulator for estimating the value of all trades undertaken by a given user.

In the preferred embodiment, a first user can view the trade list or wish list of any second user in any public community or that is a member of the same at least community that the first user is a member of. Each item of the second user's trade list or wish list that is displayed by the system is associated with at least one web link, and the first user can directly incorporate any item on the second user's wish list or trade list into the first user's wish list or trade list by actuating the associated web link.

According to another aspect of the invention an electronic bartering system is provided which associates each user with at least one community and enables users to create their own communities. An electronic bulletin board is associated with each community. Each user can specify at least one barterable item in a wish list and at least one barterable item in a trade list. Upon request, the system: compares a given user's trade list of against the wish lists only of other users that are members of the same communities as the given user in order to identify other users that desire items possessed by the given user; displays to the given user at least a portion of the trade lists of the other identified users to thereby identify potential trades for the given user; and associates each potential trade with a web link which upon actuation incorporates any potential trade item into the given user's wish list. Within a given community, the system periodically compares the wish lists and trade lists only of users within the community in order to identify a trade match, sends a message to users advising of the trade match, and receives confirmation from the users accepting or rejecting the trade match.

### BRIEF DESCRIPTION OF DRAWINGS

The foregoing and other aspects of the invention will be better understood with reference to the following detailed description and the drawings, wherein:

FIG. 1A is a block diagram of an Internet based electronic bartering system according to a preferred embodiment;

FIG. 1B is a schema of a database employed in the preferred system;

FIGS. 2-18 are various display screens of interactive web pages presented by the preferred system;

FIG. 19A is a schematic diagram exemplifying a two-way trade match;

FIG. 19B is a schematic diagram exemplifying a three-way trade match; and

FIG. 19C is a schematic diagram exemplifying all potential trades for a given user.

### DETAILED DESCRIPTION OF PREFERRED EMBODIMENTS

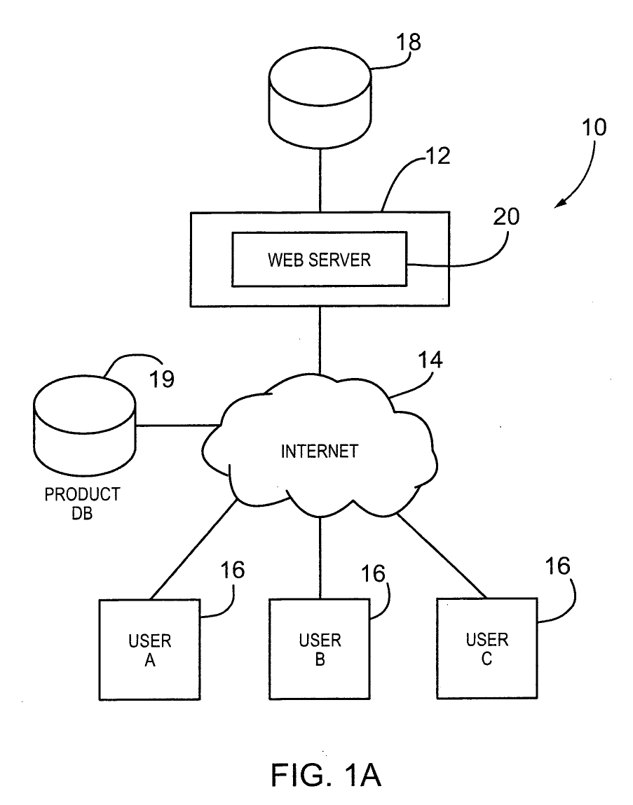

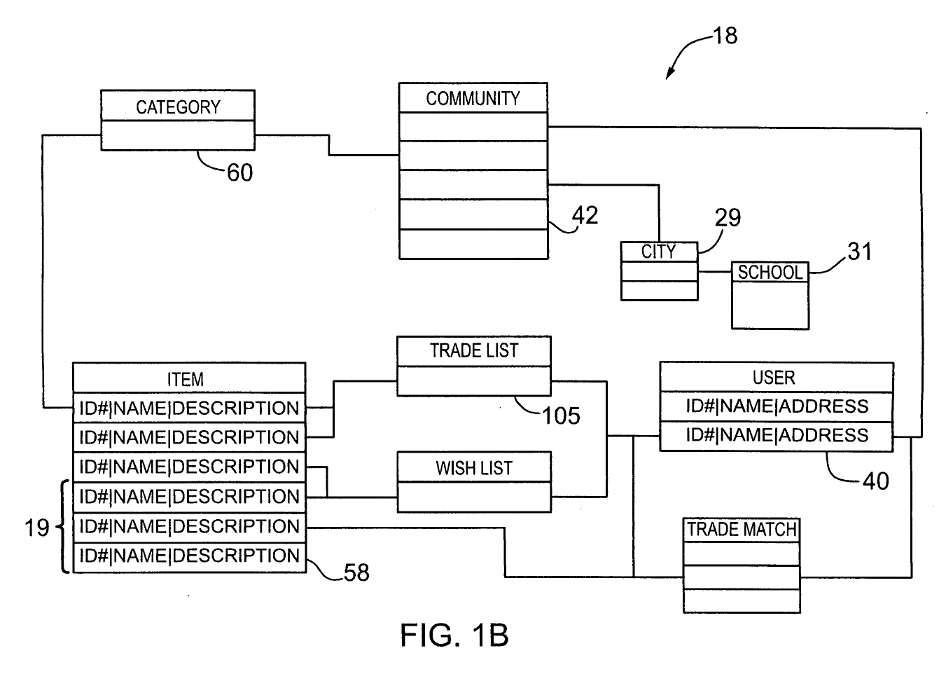

FIG. 1 shows a system block diagram of the basic elements of an electronic bartering system 10 according to the preferred embodiment. The system 10 includes a central web server 12 which communicates with a plurality of client computers 16 via a communications network 14 such as the Internet. The server 12 accesses a central database 18 and executes web server software 20 that provides the user interface for a web site. (In the drawings, the web site is identified as the Commuto™ site.) The web server 12 also communicates with a commercial product database 19, as discussed in greater detail below.

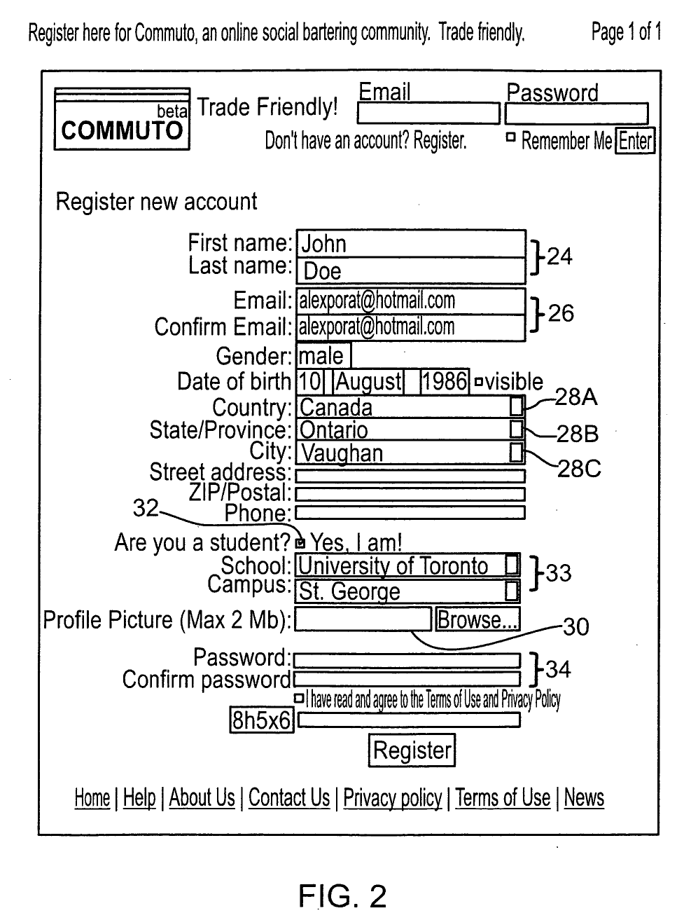

FIG. 2 shows a new user registration screen 22 which is used to create a user profile that will be stored in the central database 18. As will be seen, the user inputs his or her name 24, email address 26, and geographical data 28, including country 28A, state or province 28B, and city 28C. In addition the new user may associate a picture 30 with his or her profile, and indicate at check box 32 if the new user is a student, in which case the user is prompted to enter their school particulars 33 such as school name and campus location. A password 34 is also associated with the user's profile. Upon registration, a user profile 40 is created and stored in the central database 18, as seen in the database schema of FIG. 1B. The system 10 links each user with one or more communities 42, and stores the links (as well known in the art) in the central database 18.

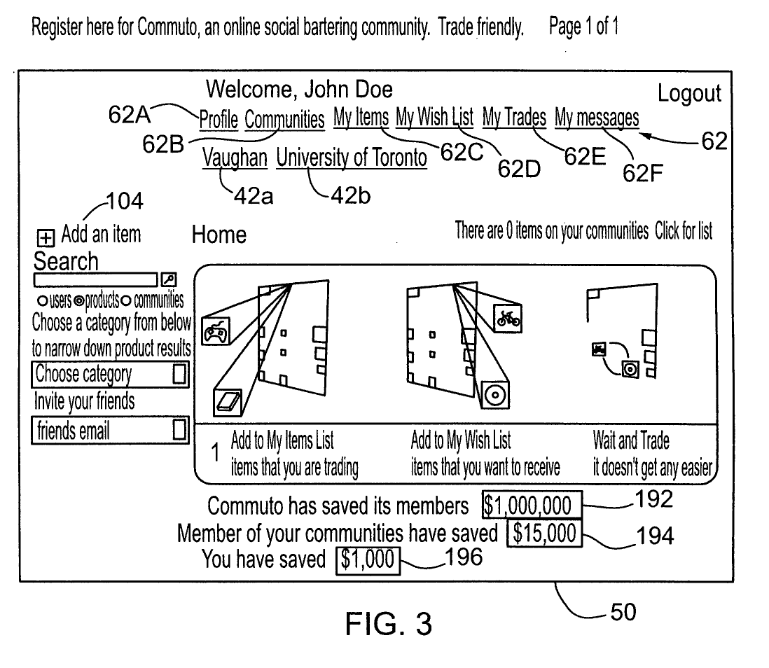

FIG. 3 shows a post registration screen 50 that arises after registration screen 22. Once the registration is completed the system 10 displays a common main menu 62 (see FIG. 3) on each web page. The menu choices (which are implemented as web links) include: ‘Profile’ 62A, ‘Communities’ 62B, ‘My Items’ 62C, ‘My Wish List’ 62D, ‘My Trades’ 62E, and ‘My Messages’ 62F.

The ‘Profile’ menu choice 62A enables the user to edit his or her system profile created during registration.

The ‘Communities’ menu choice 62B provides functions relating to various aspects of communities 42. Communities 42 are an important aspect of the system 10 because they engender or otherwise encourage the establishment of a social network amongst the users as discussed in greater detail below

Certain communities 42 are preferably pre-designated or otherwise static in the system 10. These include most particularly users' cities and schools, which are preferably provided as pre-populated database tables 29, 33 as shown in the database schema of FIG. 1B. (As discussed above upon registration the user selects from amongst pre-designated cities and schools, where applicable, by means of a finite item list box as shown in FIG. 2, which draws data from tables 29 and 33.) Upon registration, each new user is assigned to at least one default community, which is preferably the user's city. In addition, if the new user is a student that user is also preferably assigned to his or her corresponding school community.

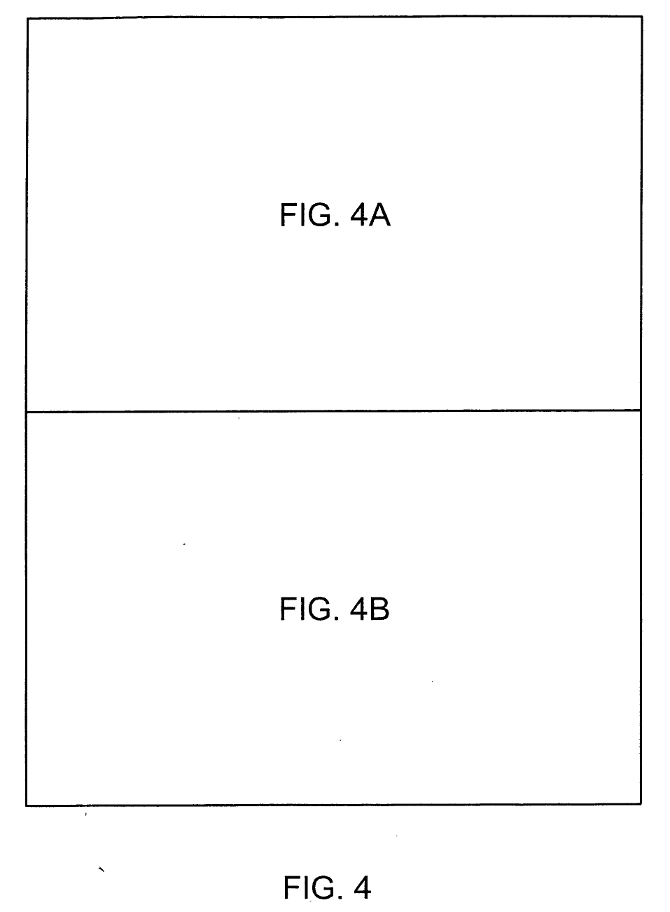

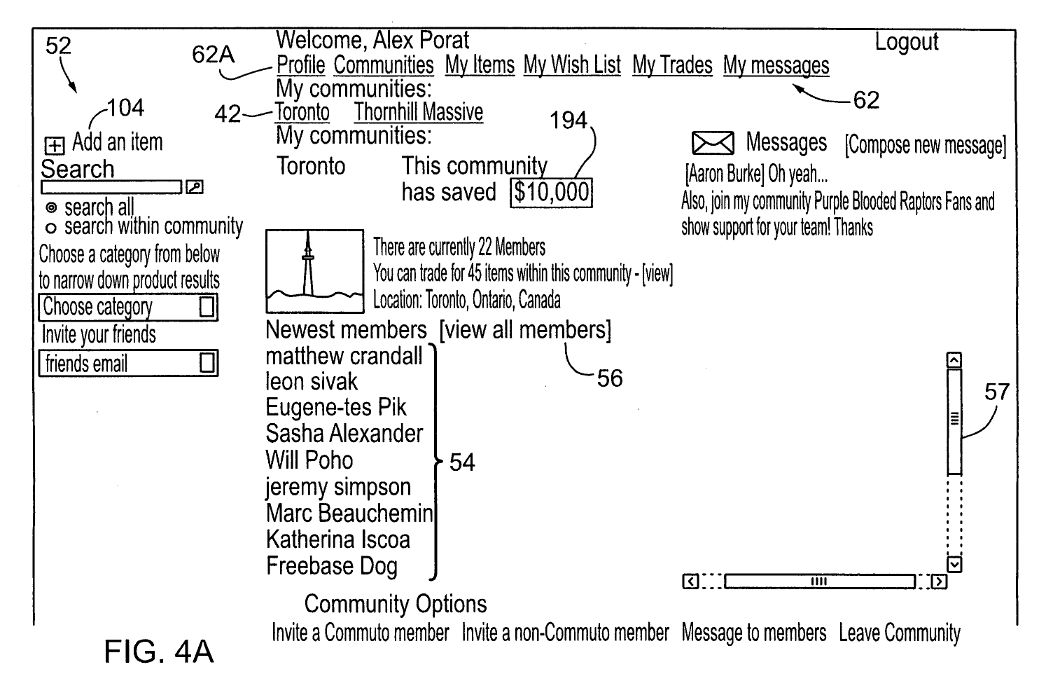

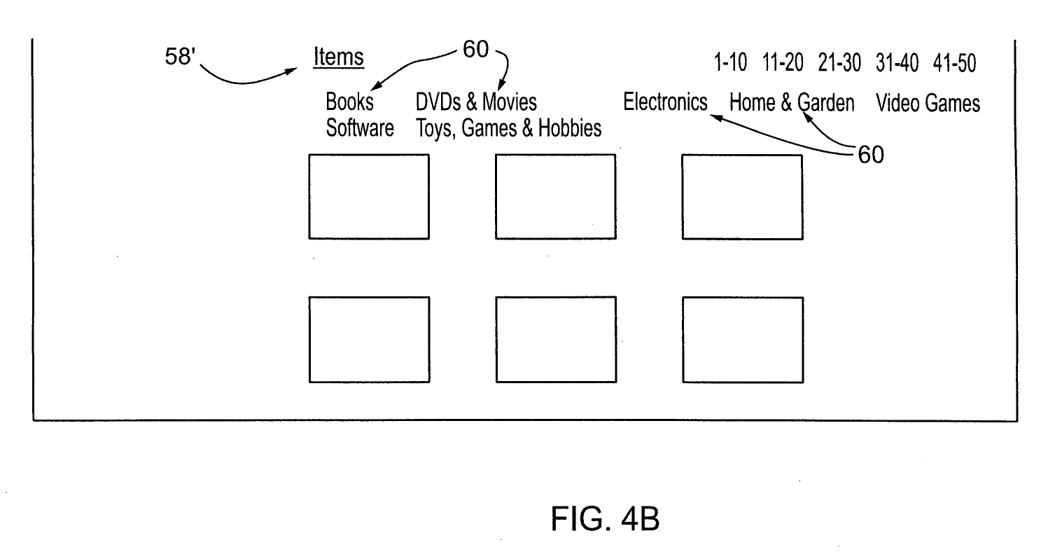

As will be seen from the sample data in screen 22 of FIG. 2 and screen 50 of FIG. 3, new user John Doe has been assigned to two pre-designated communities 42a and 42b corresponding to John Does's city (e.g., Vaughan) and school (e.g., University of Toronto). The user's associated communities 42 are displayed as a hyperlink or web link 42a, 42b, and the number of members in the community is also displayed (the number is shown in superscript next to the community name). Accessing the web link 42a, 42b will lead to a screen 52, such as shown in FIG. 4, which lists the members of the community. FIG. 4 exemplifies the “Toronto” community, which has 22 members. The newest members are shown at location 54 as web links which, when activated, will lead the user to the newest member's personal profile 42. Alternatively the user may access a full membership list via web link 56.

As seen in FIG. 4, within a given community 42, the various items 58 available for barter within that community are shown in the ‘Items’ section 58′. The items 58 are preferably categorized into pre-designated classes or item categories 60, as will also be seen in the database schema of FIG. 1B. Clicking on a particular category 60 leads the user to view all the items 58 available within the given community 42 (e.g., Toronto) for barter in that particular category.

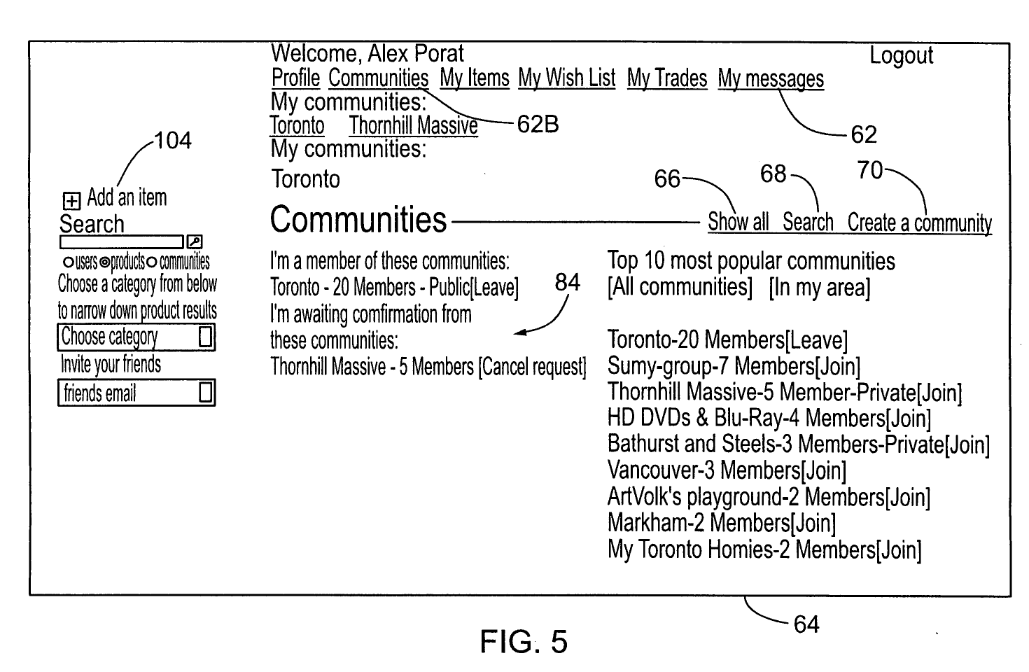

New or additional communities 42 can also be dynamically created by users. For instance, clicking on the ‘Communities’ menu choice 62B leads to screen 64, shown in FIG. 5. This screen 64 specifies the communities that the user is currently a member of (e.g., Toronto), the communities that the user has elected to join but is not yet a member of (e.g., Thornhill Massive), and the most popular communities, by membership, in the system 10. The user may elect to see all communities by clicking on a ‘show all’ link 66; search for specific communities by clicking on a ‘search’ link 68; or create a new community by clicking on a ‘create a community’ link 70.

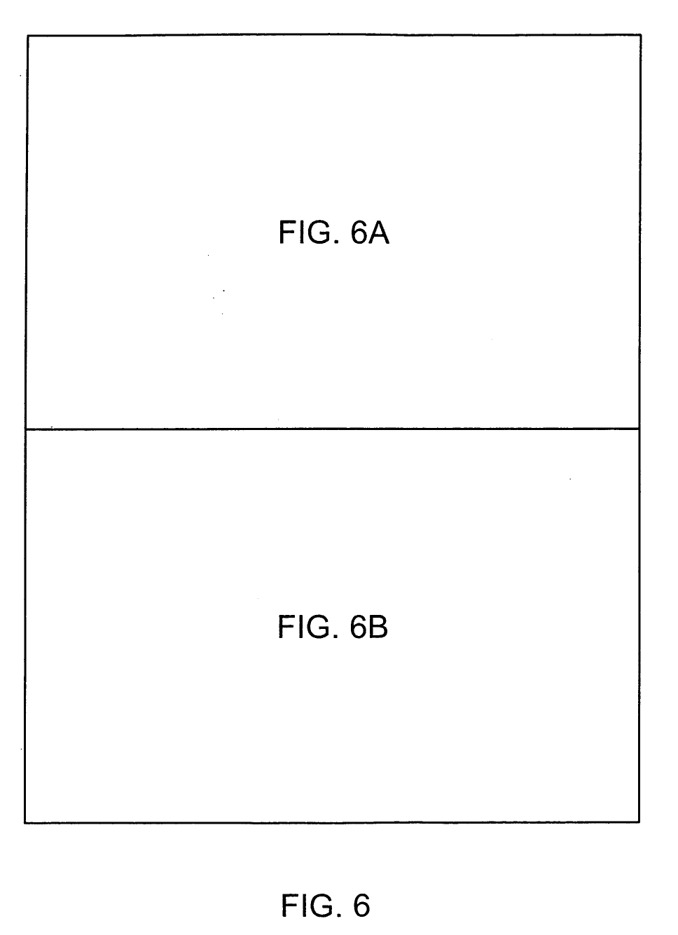

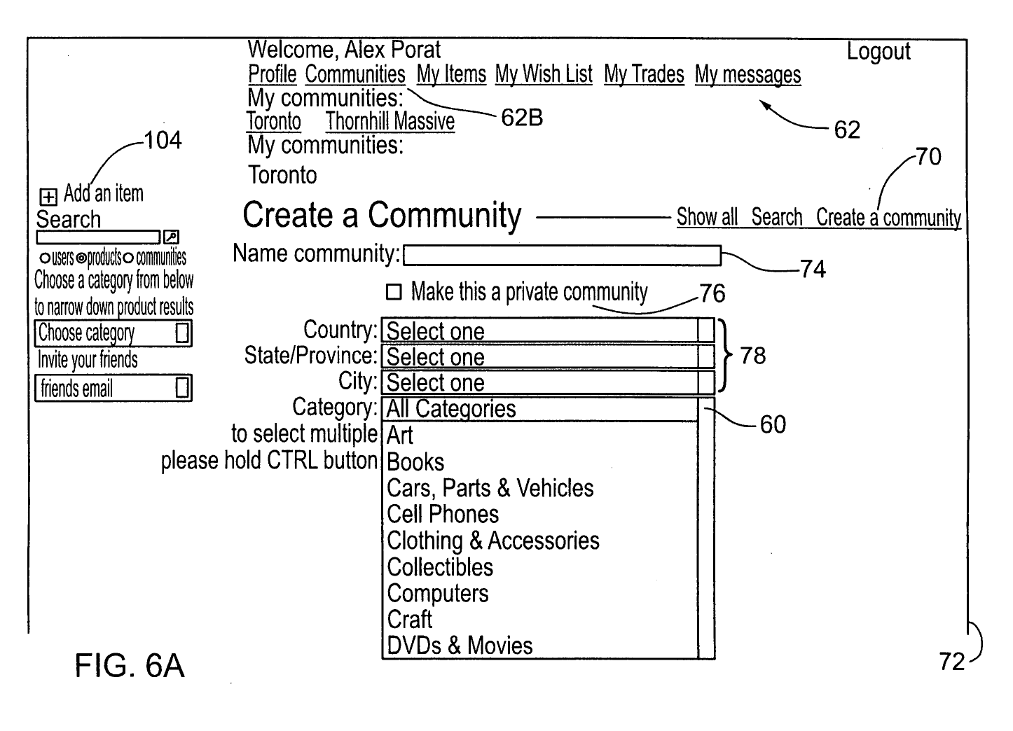

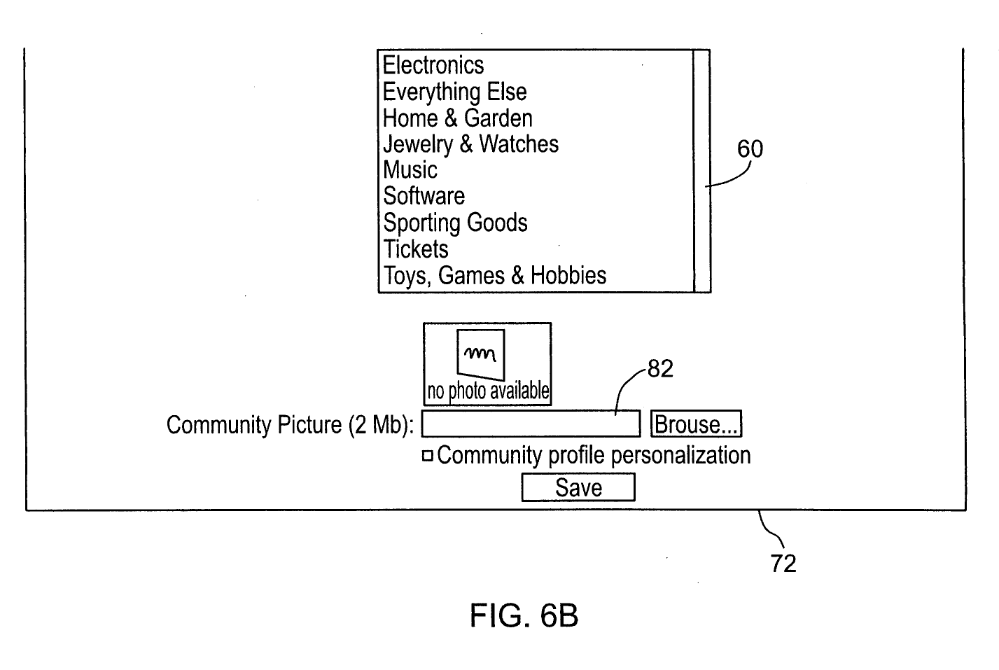

FIG. 6 shows a screen 72 enabling the user to create a new community 42. The system 10 associates the following data with each community: community name 74, privacy status 76, geographical data 78, categories 60 of barterable items associated with the community; and a picture 82. This data is stored in the central database 18, and the linkage between categories 60 and communities 42 are also shown in the database schema of FIG. 1B.

The privacy status 76 indicates whether or not the new community can be freely joined by any user of the system 10. If the status is set to public, then any user can join the community. If the status is set to private, then the system 10 will notify one or more moderators of the private community of a request to join that community. The one or more moderators may approve or disapprove the request, as discussed in greater detail below. While a user's request to join a community is pending, the pending community membership is displayed as “awaiting confirmation”, as will be seen for example at location 84 in the initial community screen 64 (FIG. 5).

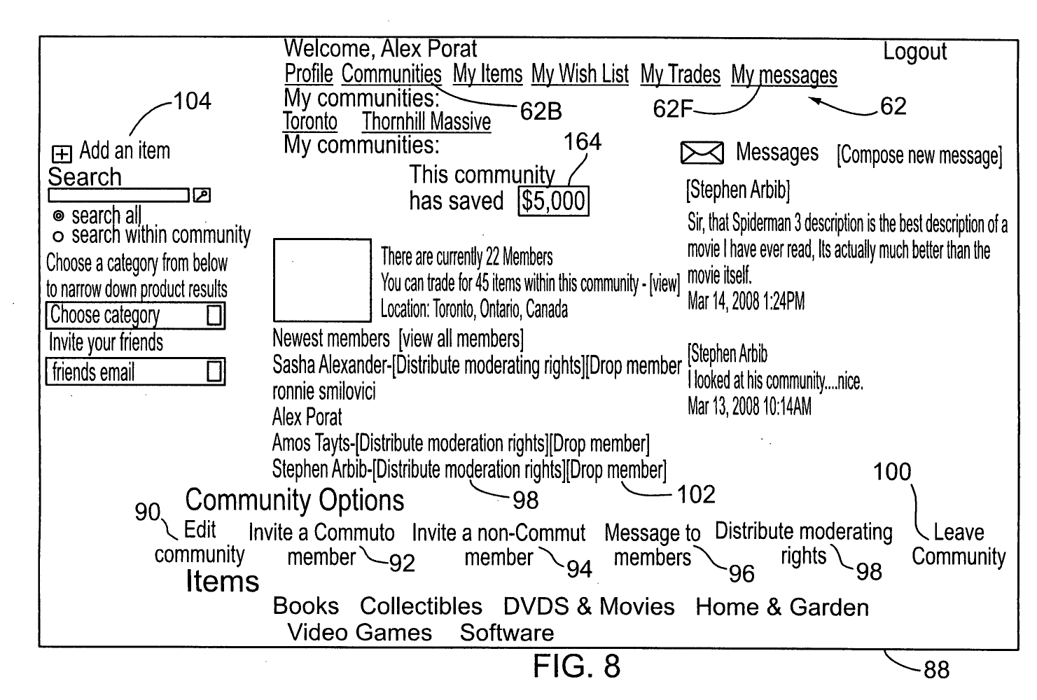

The moderator(s) of a private community can vary. The creator of the community is the initial moderator. However, as seen in screen 88 of FIG. 8, any moderator of any private community can grant any other member of that community the right to be a moderator thereof. More particularly, by accessing one the following links, a moderator may:
Edit Community 90: Enables moderator to edit the categories of items in the community.
Invite a Member 92: Enables moderator to invite a registered user of the system 10 (referred to in the drawings as Commuto™) to the community. In this case the system 10 asks for the name of the user and sends an e-mail message to that user's external e-mail account. In addition, upon login to the system 10, the invited user will also see the message under the system My Messages menu item 62F.
Invite a non-Member 94: Enables moderator to invite an external party to be a member of the system 10 and the community. In this case the system 10 asks for the e-mail address of the external party and sends an automated e-mail message to e-mail address inviting the party to join the system 10.
Send Message to Member 96: Enables moderator to send a private message to another member of the community. That message appears under the My Messages menu item 62F.
Distribute Moderating Rights 98: Enables moderator to provide moderator rights to other members of the community. In this case, the system 10 sends an
Leave Community 100: Enables moderator to delist his or her self from the community.
Remove Member 102: Enables moderator to remove a specific member from the community, e.g., due to wrongful behavior.
Delete Community 104: Enables moderator to delete the community. This is preferably only possible if the moderator is the only person in the community.

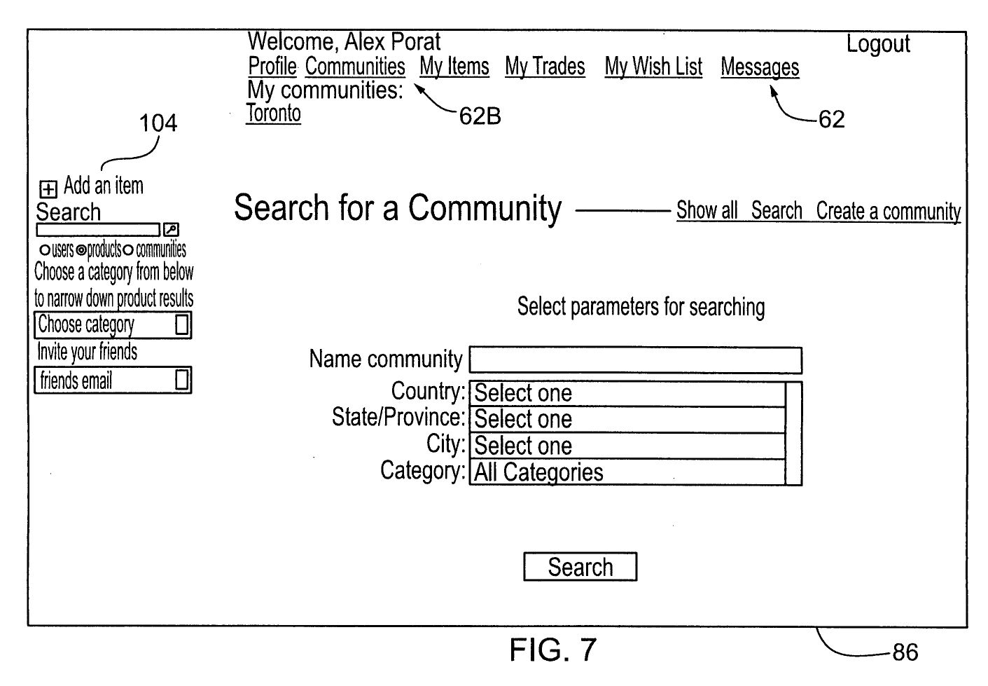

Referring back to FIG. 6, the geographical data 78 and item categories 80 provide useful attributes that enable users to search for communities of interest. A community search screen 86, accessible via search link 68, is shown in FIG. 7. Preferably, as shown in screen 72, FIG. 6, each user-generated community is associated with a geographic location and thus it will be easy to find all communities in a given geographic location.

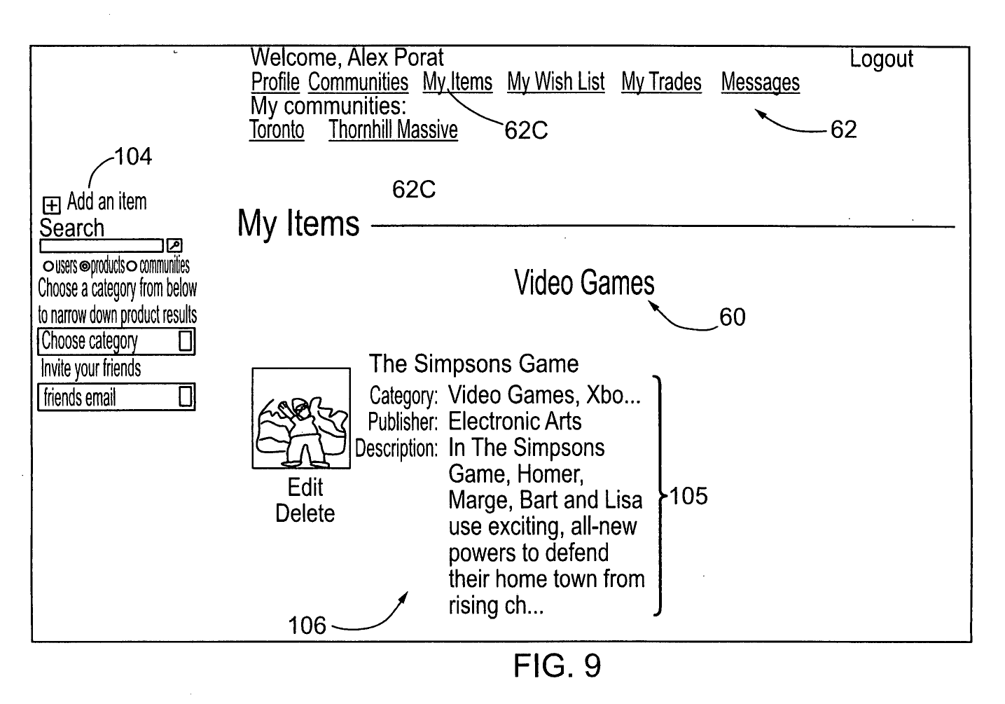

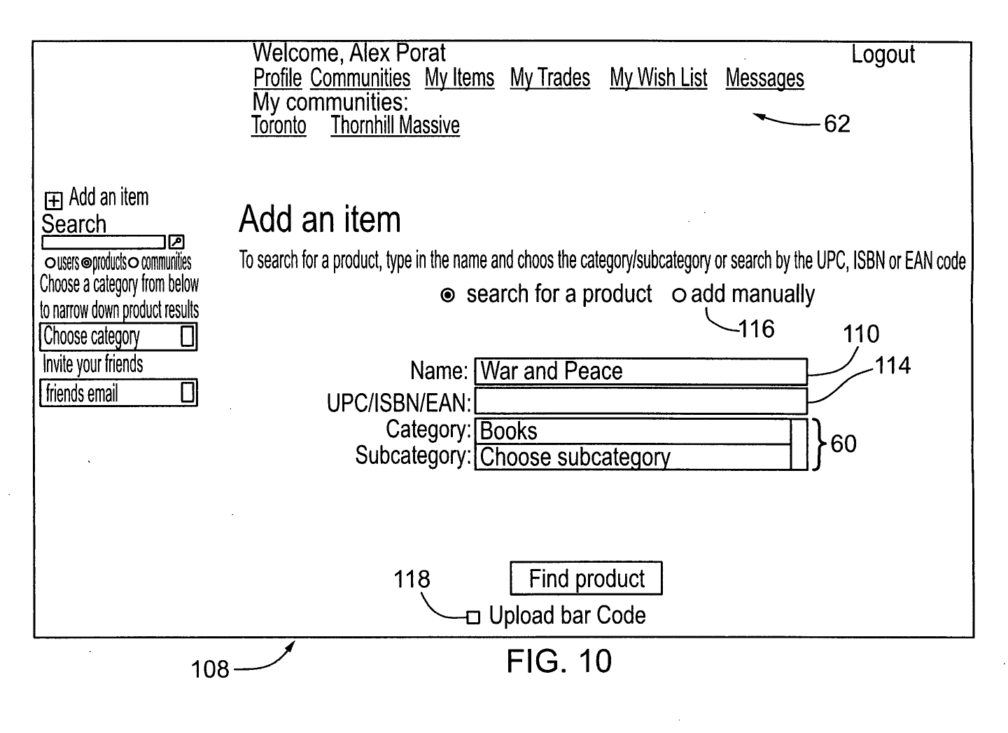

The items 58 that the user wishes to trade are listed under the ‘My Items’ menu choice 62C. FIG. 9 shows a screen 106 displayed in response to accessing menu item 62C, which displays an items-available-for-trade list 105 under one or more various categories 60. (As seen in the database schema of FIG. 1B, each user profile 40 is associated with one trade list 105 comprising multiple items 58, each associated with a category 60.) Items may be added to the items-available-for-trade list 105 at any time by accessing an ‘Add an Item’ link 104 present on most screens. Clicking on link 106 leads to an ‘Add an Item’ screen 108 shown in FIG. 10. The system 10 accepts commercial items that are associated with a standardized product number (UPC—Universal Product Code; ISBN—International Standard Book Number; or EAN—European Article Number), and the system can also accept non-standardized items as described in greater detail below.

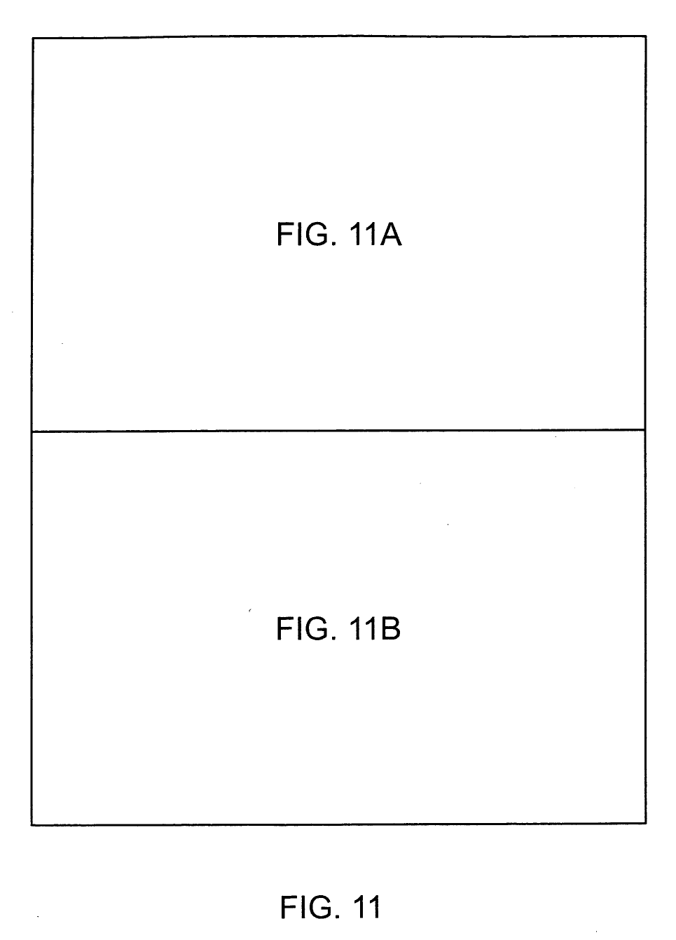

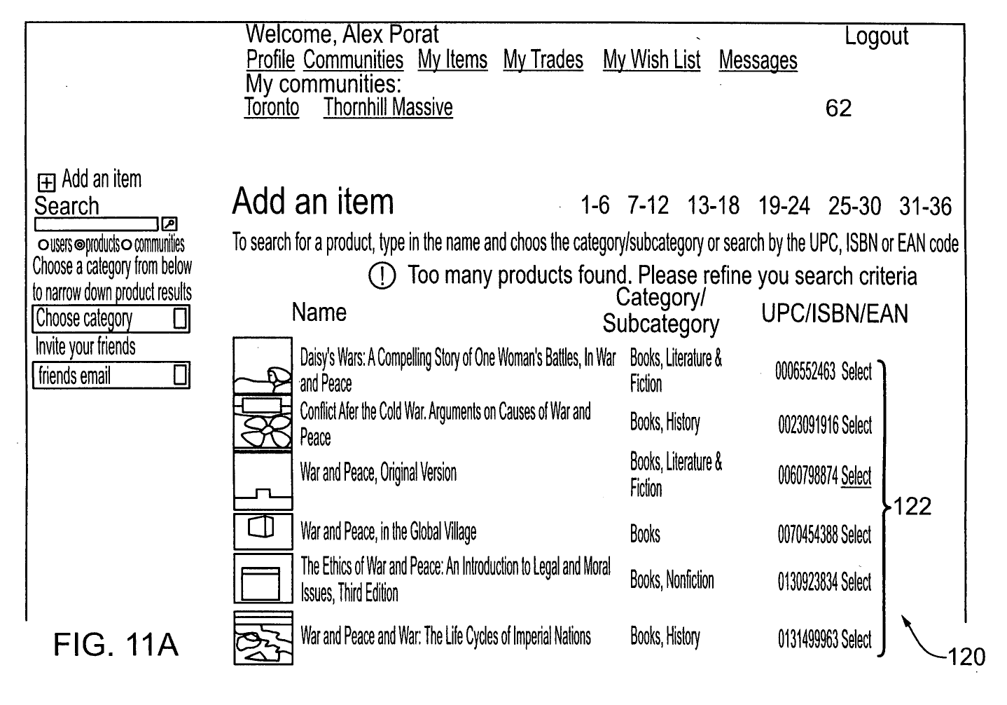

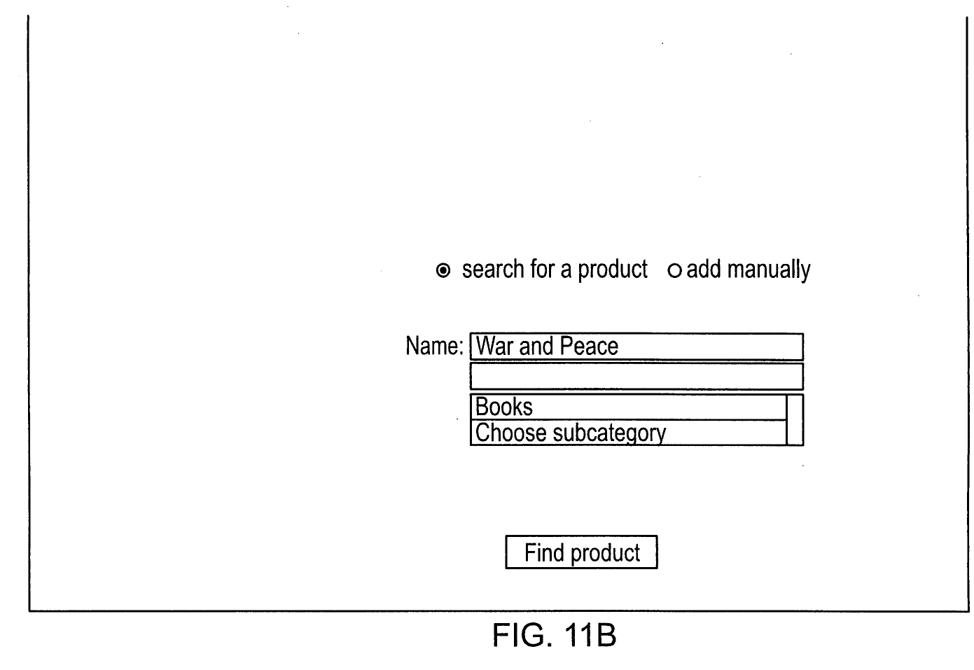

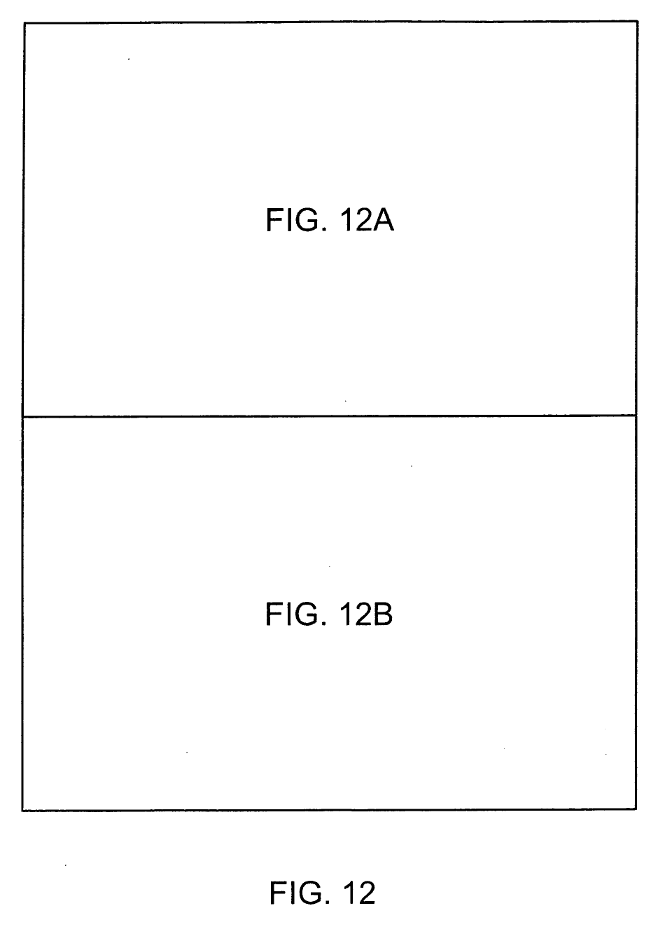

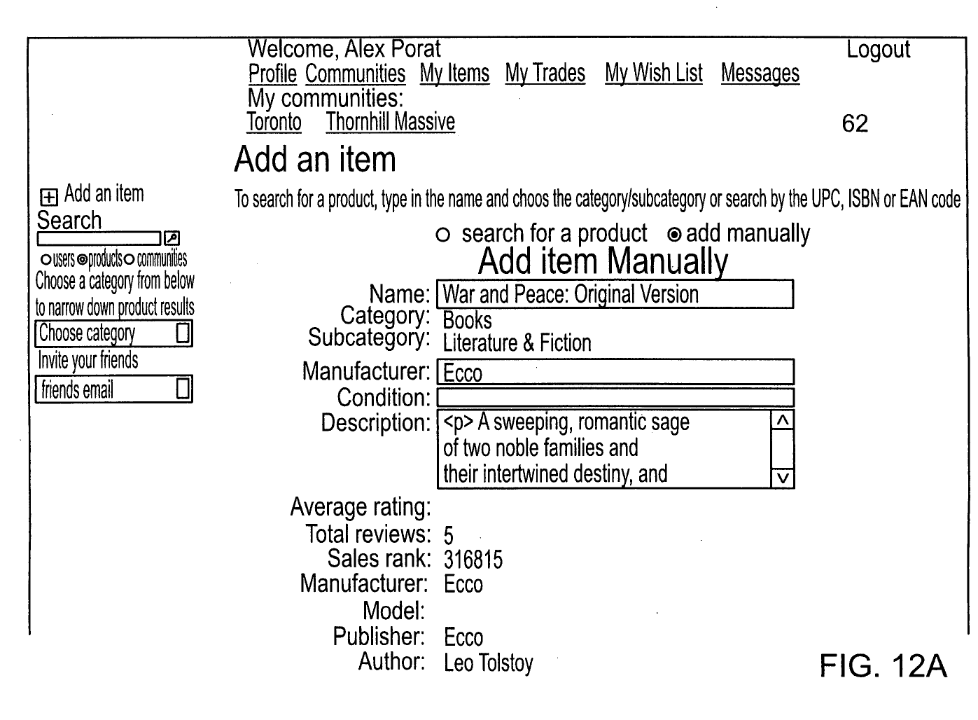

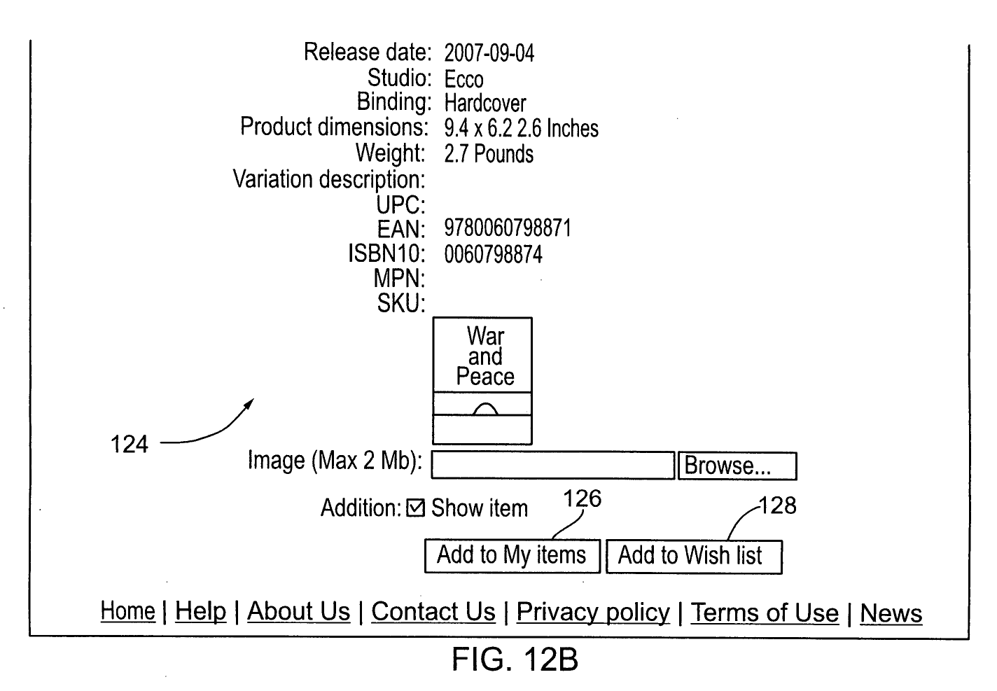

As shown in FIG. 10, a commercial item may be searched by name 110 to find its standardized product number. The search may also be delineated by the item category 60. In the example shown in FIG. 10 the system 10 accesses the commercial product database 19 (such as available from Amazon.com), which stores millions of commercial products, to conduct a search for “war and peace”. FIG. 11 shows screen 120 displaying multiple items 122 that meet the search criteria. By selecting the Tolstoy book at link 122A various details of the book stored in the product database 19 (including a standardized description) are shown to the user in screen 124, FIG. 12. The ‘Add to My Items’ link 126 adds the particular item to the user's trade list 105, and the ‘Add to Wish List’ link 128 adds the particular item to a list of items that the user desires to acquire (referred to as a “wish list” 144, described below).

Alternatively as shown in FIG. 10 the standardized product number of an item 58 may be directly entered into the system 10 at box 114. Recognizing that the user is not likely to have such information readily available, the system 10 also enables the user to upload a photo of the item's bar code to the system 10 via checkbox 118. In this case the system 10 requests the identity of an image to upload and will scan the image in order to recognize a bar code, as such image processing software is known in the art per se. Once the bar code is captured the commercial item may be identified by searching the commercial product database 19 and a screen such as shown in FIG. 12 is displayed to enable the user to add the item to his or her trade list 105 or wish list 144. Thus, for instance, a user out shopping may come upon an item that he or she desires, snap a shot of the bar code with his or her cell phone, and then easily upload the bar code to the system 10. The cell phone includes software that sends the user's system ID (see FIG. 1B) and the bar code via an e-mail message to the system server. The system server, in turn, identifies the item and associates it with the user's wish list.

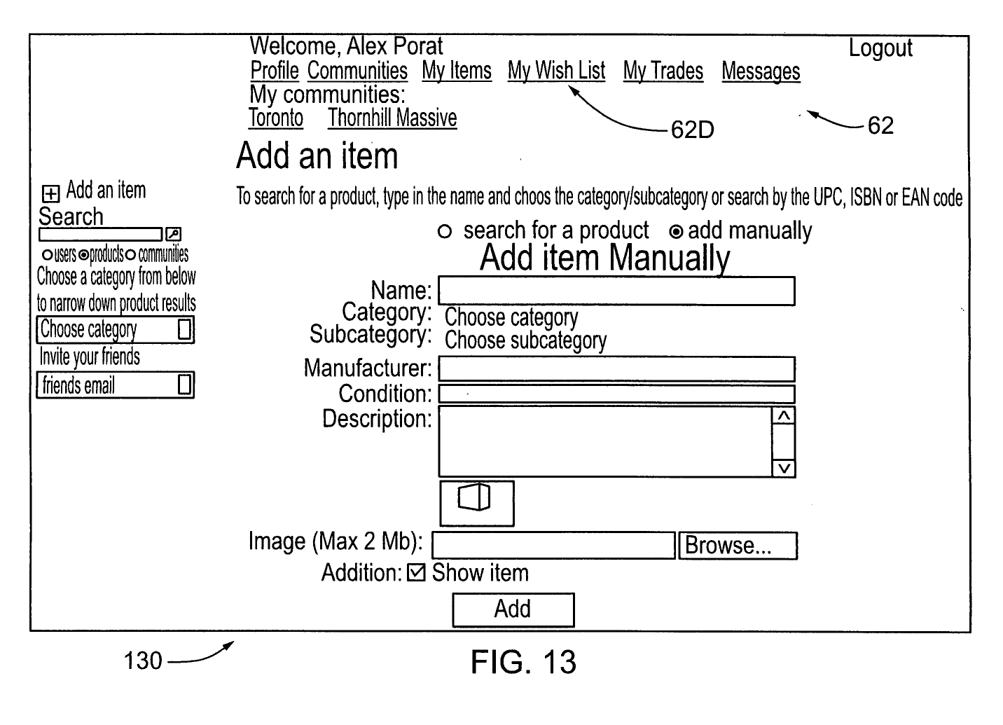

In addition, the system 10 will also accept for trade non-standardized items. In this case as seen in FIG. 10 the user checks off the ‘add manually’ check box 116, which then brings up another screen 130 shown in FIG. 13 that enables the user to provide additional data about the non-standardized item such as its condition and a custom description.

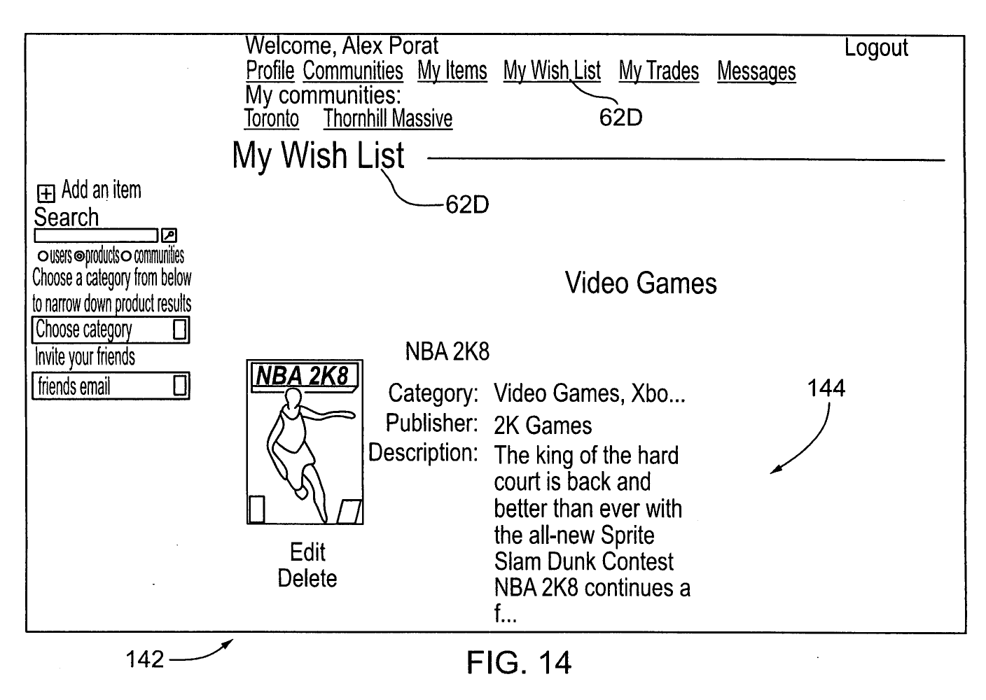

The ‘Wish List’ menu choice 62D displays the items that the user wishes to acquire. An example of a wish list 144 is shown in screen 142 of FIG. 14. (See also the database schema of FIG. 1B, which shows that each user profile 40 is associated with one wish list 144 comprising multiple items 58, each associated with an item category 60.) Items may be added to the user's wish list 144 as described above. Note that each user's wish list 144 is present or visible in every community in which the user is a member. The exception is with communities that are established or otherwise defined to be associated with certain item categories. In this case, user wish list items that do not fall within the designated categories will not be visible within the community.

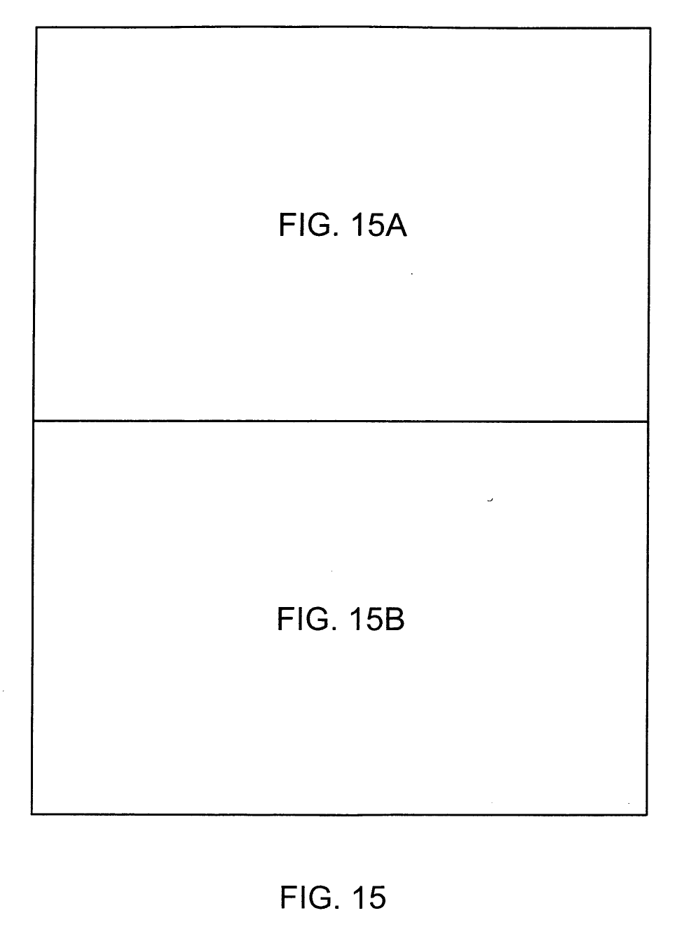

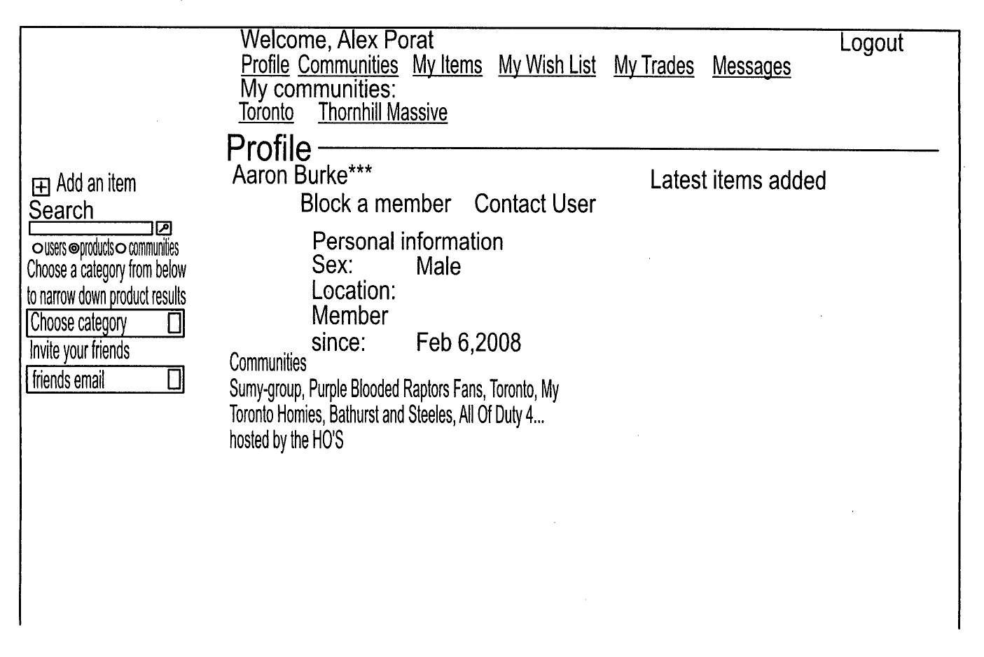

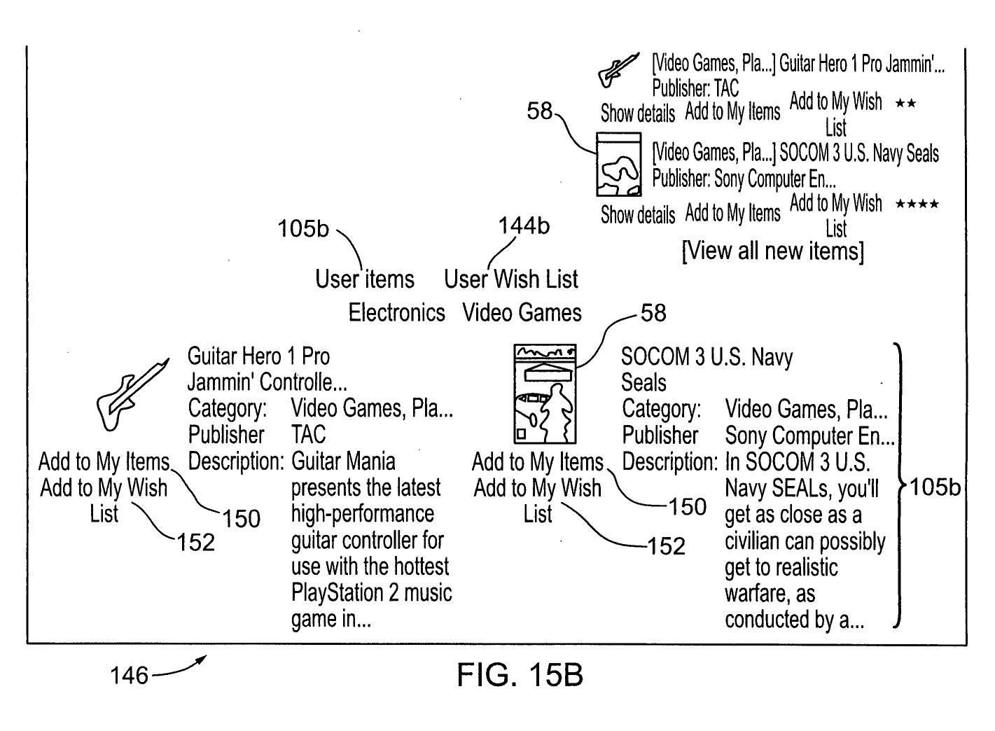

However, a given user may see all communities hosted by the system 10, and can view the members of each public community and each private community that the given user belongs to. Subject to these limitations, every user can view the items-available-for trade lists 105 and the wish lists 144 of other members. For example, FIG. 15 shows a sample screen 146 that a first user (e.g. Alex) is able to view of a second user's (e.g. Aaron) items-available-for trade list 105b and wish list 144b (via link). The first user is also able to add any of the items displayed on the second user's lists 105b, 144b to the first user's lists 105, 144 via ‘Add to My Items’ links 150 or ‘Add to My Wish List’ links 52 that are associated with every displayed item 58. This feature makes it especially easy to for a user to add to his or her lists 105, 144 any non-standardized items introduced by others into the system.

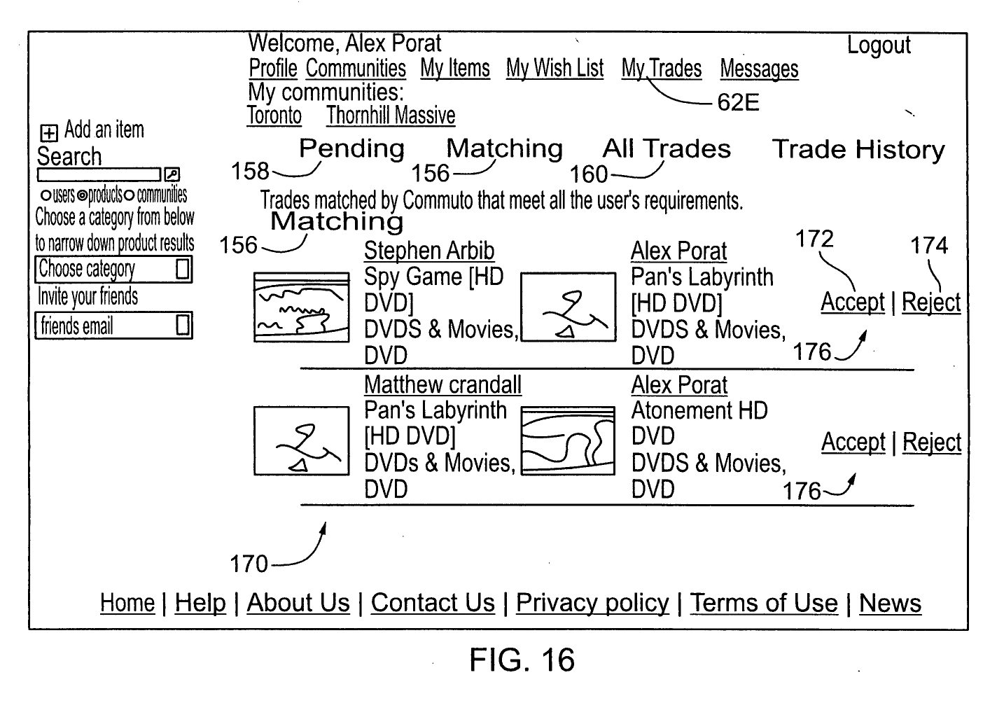

Referring additionally to FIG. 16, the ‘My Trades’ menu choice 62E displays the following links for a given user: ‘Matching Trades’ 156, ‘Pending Trades’ 158, and ‘All (potential) Trades’ 160.

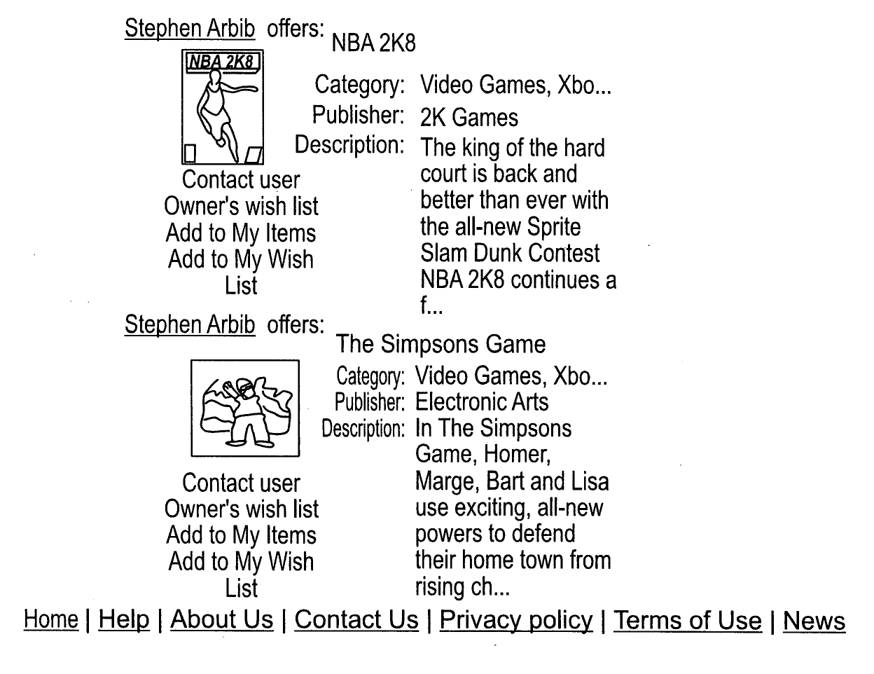

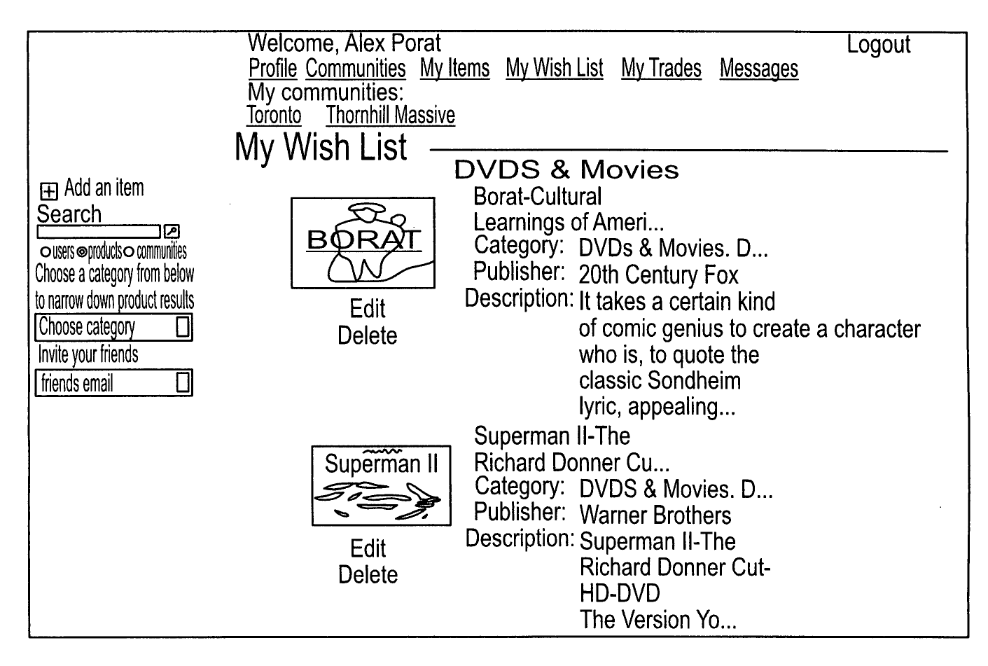

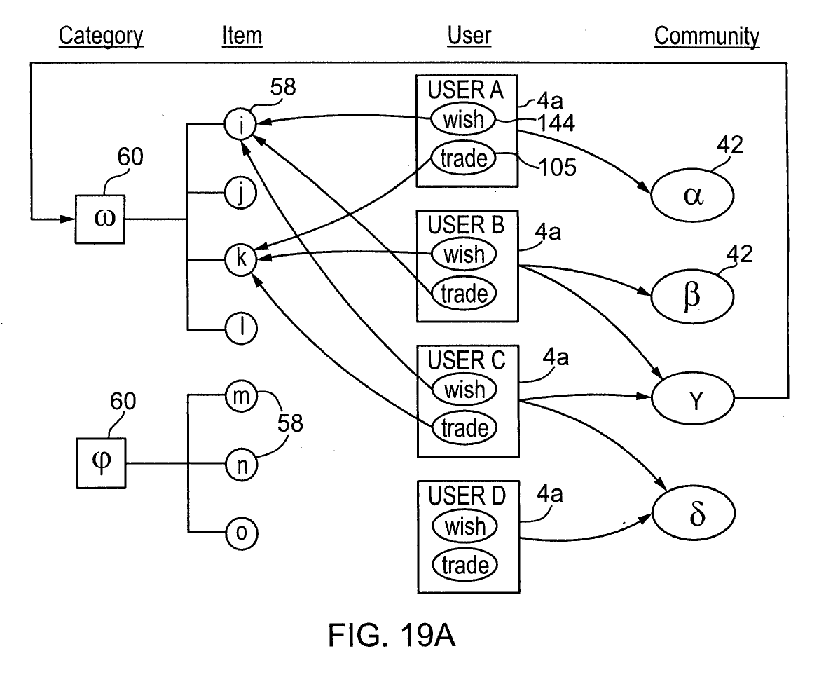

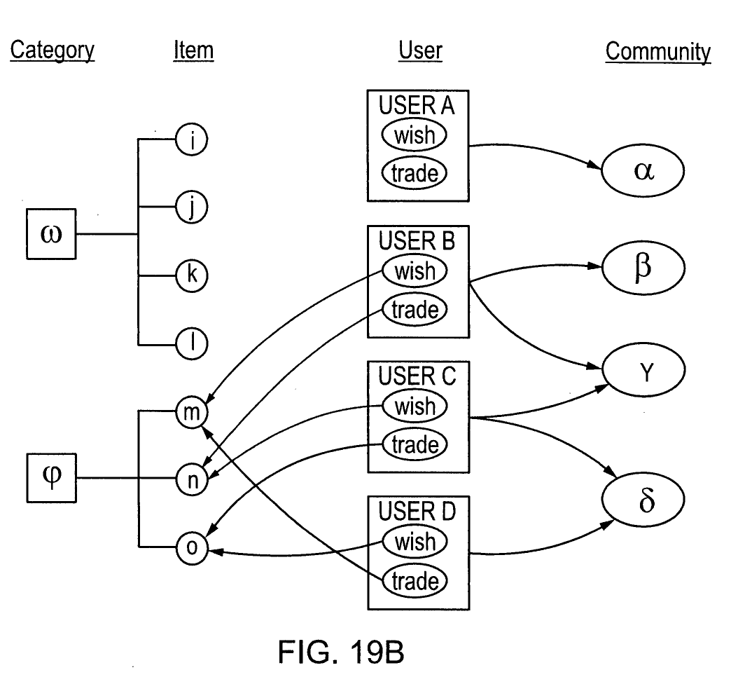

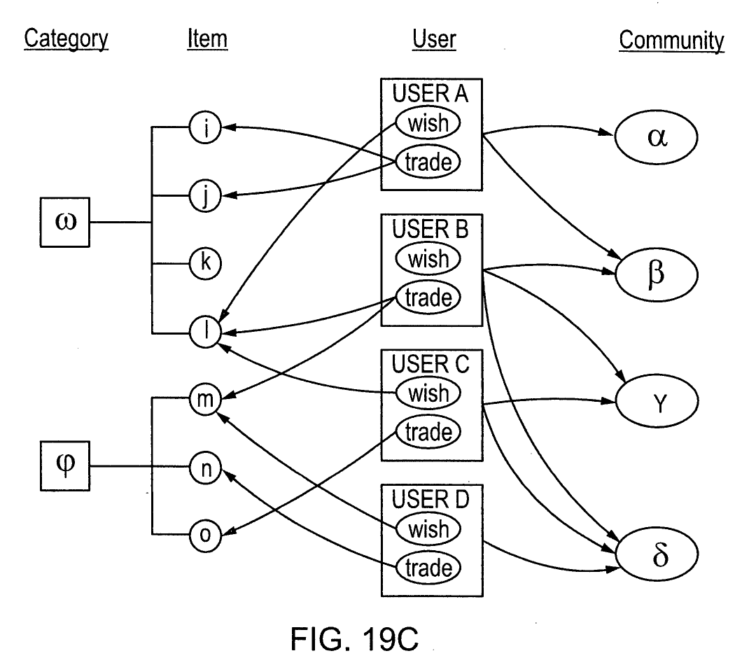

The ‘Matching Trades’ link 156 leads to a screen 170, FIG. 16, which lists trade matches 176. The system 10 periodically runs a matching process wherein each user's wish list 144 is compared against other members' items-available-for-trade lists 105 within mutual communities (i.e., a user's wish list is not compared against other user's trade lists if the users belong to completely different communities 42). A two-way trade match is recognized when, within a common community, an item on a first user's wish list 144 is appears on a second user's trade list 105 and another item on the second user's wish list 144 appears on the first user's trade list 105. Referring additionally to the schematic diagram of FIG. 19A, an example of the matching process is shown. In this example, user B wishes item k and has item i available to trade, and user C wishes item i and has item k available to trade. As users B and C belong to the same community (Gamma), and as the items i and k fall within the category (Omega) that community Gamma is limited to, a two-way trade match (schematically represented by the thicker lines) between B and C is recognized. Note however, that while user A has the same wish and trade lists 144, 105 as user C a trade match is not recognized between users A & C since they do not share a common community.

(Note that in the schematic diagrams of FIGS. 19A-C the lack of a link between a community 42 and a category 60 indicates that the community is associated with all categories; conversely if one or more links are shown between a community and one or more categories then the community is limited to the linked categories.)

The system 10 is also capable of recognizing a three-way trade match amongst members of a given community. An example of this is provided in the schematic diagram of FIG. 19B.

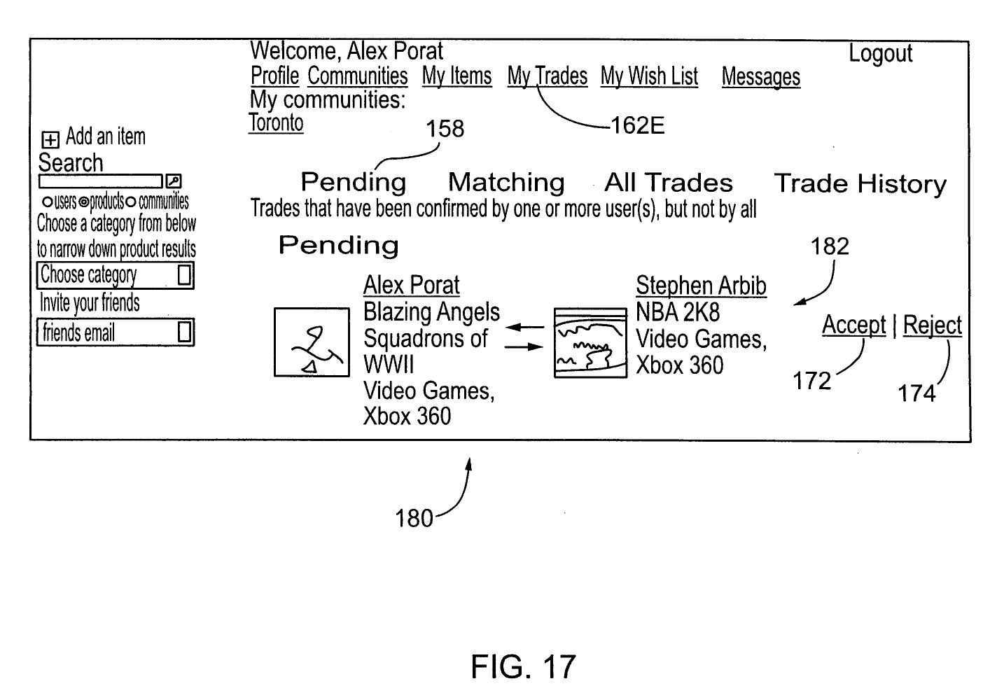

When a trade match 176 is identified, the system 10 displays same in screen 170, FIG. 16. In addition, the system 10 sends the first and second (and possible third) users automated e-mails advising of the trade match 176. The e-mail includes a link to the system 10 which points to the matching trades screen 170. The matching trades screen 170 includes ‘accept’ and ‘reject’ links 172, 174 for each trade match 176. By clicking on the ‘accept’ link 172 the trade match 176 is accepted by that party, and thereafter the trade match 176 is moved for that user to a pending trades list as exemplified in screen 180, FIG. 17, which is accessible via the ‘Pending Trades’ link 158. In addition, the system 10 removes the corresponding items 58 from the user's wish list 144 and items-available-for-trade list 105. A pending trade 182 remains pending until all parties have accepted it, after which the system 10 removes the pending trade 182 from the users' pending trade lists. If any party rejects the pending trade, the pending trade 182 is removed from the system 10 and the corresponding items are added to the respective users' wish lists 144 and items-available-for-trade lists 105.

In addition, when a trade match is accepted, the system 10 updates various accumulators that keep track of the value of trades. As the majority of the items traded in system 10 are expected to be standardized items, the associated manufacturers suggested retail prices (MSRP) will be stored in the product database 19. For each accepted trade, personal, community and global value accumulators 192, 194, and 196 respectively are updated based on the value of all items involved in the trade and displayed to the user, as exemplified in FIG. 3. These accumulators are preferably displayed on other suitable screens of the web site, as desired. For trades that involve non-standardized goods, the system 10 updates the relevant accumulators by employing a nominal value for the trade equal to the average value of all items listed per category, per community.

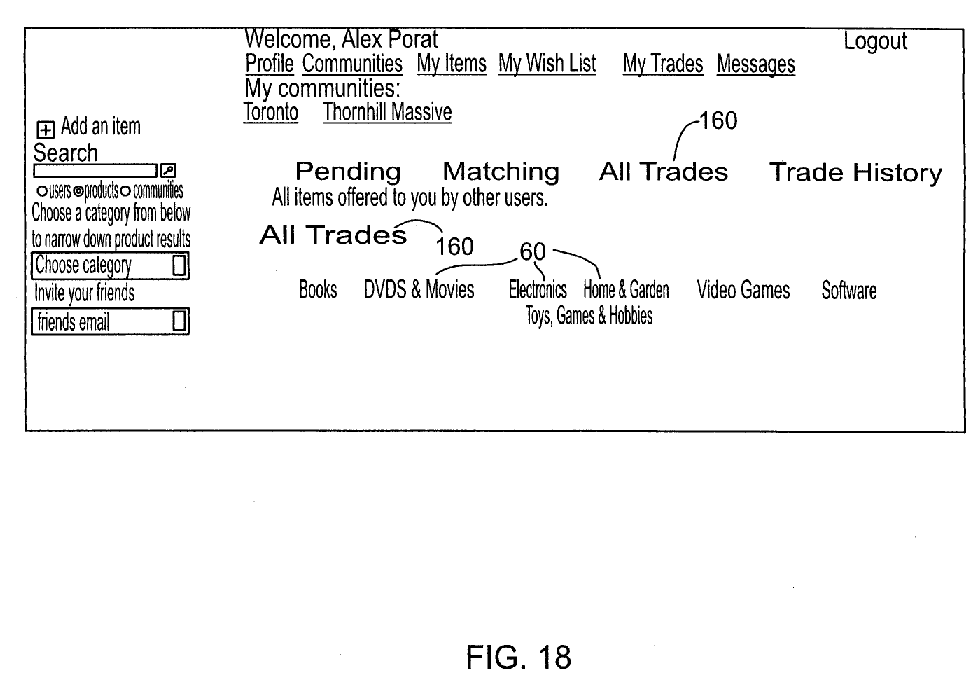

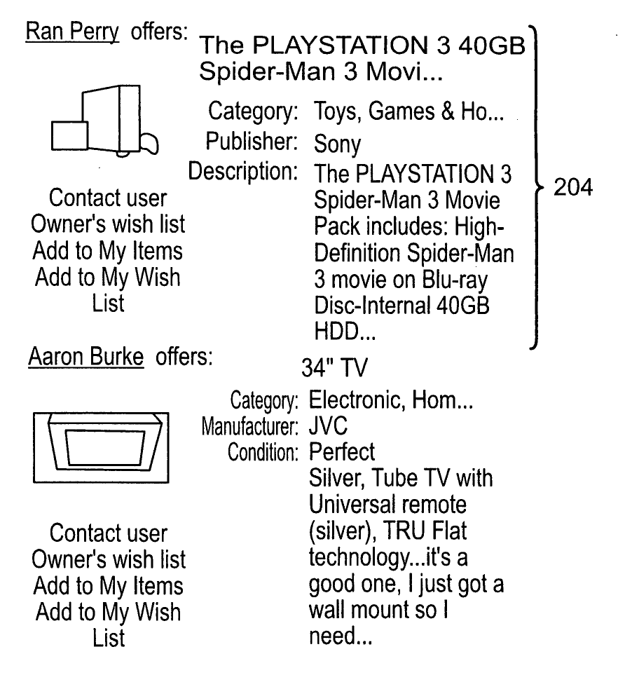

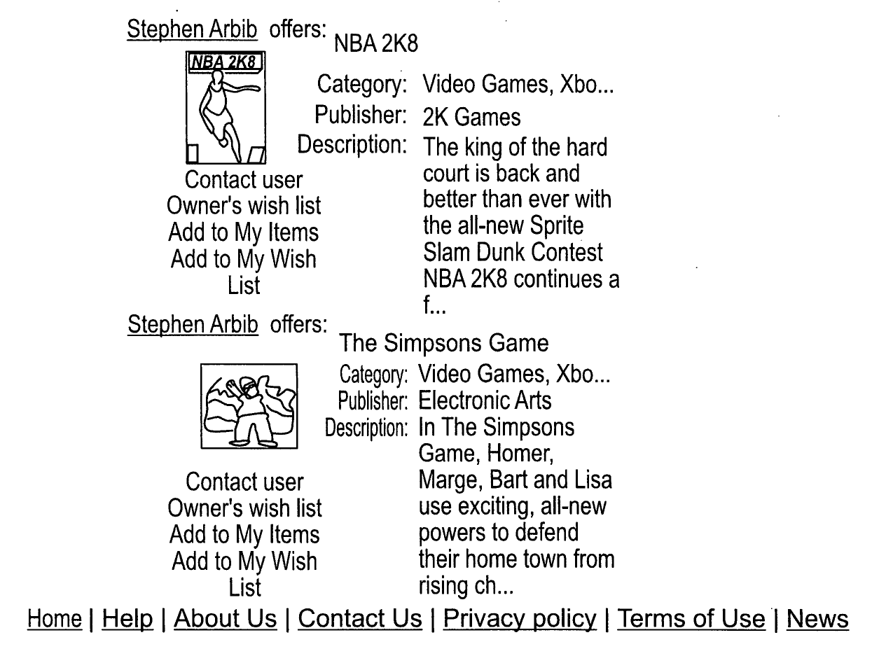

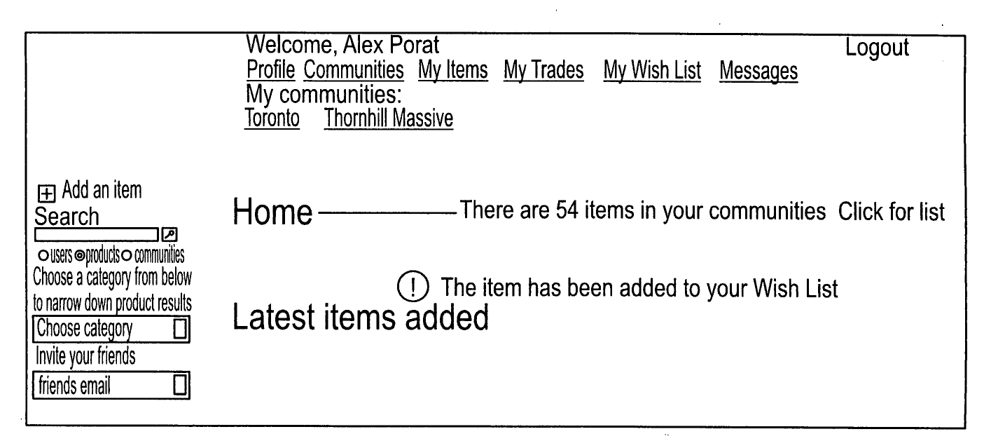

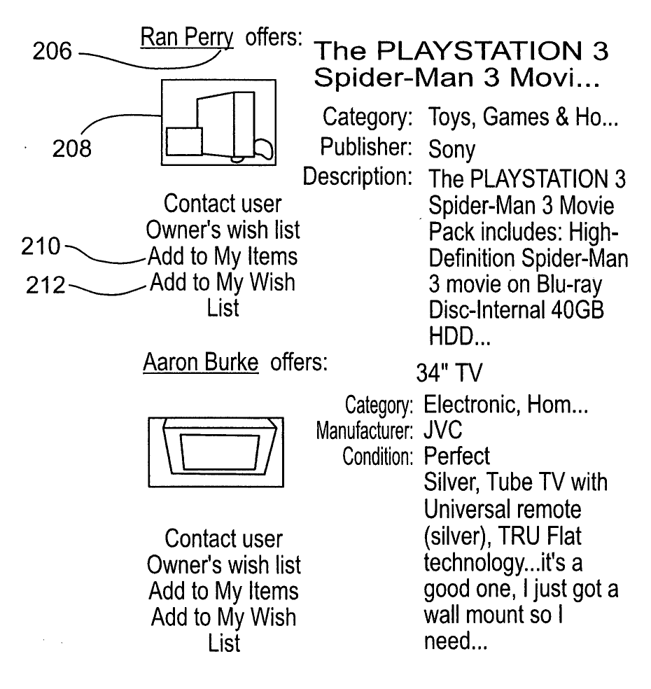

The ‘All (potential) Trades’ link 160 leads to a screen(s) (such as screen 200, FIG. 18A) that lists all the items that a given user could potentially receive from other members (belonging to the same communities) in exchange for the items on the given user's items-available-for-trade list 105. An example of all potential trades is shown in the schematic diagram of FIG. 19C. In this example, user B has items l and m in his or her items-available-for-trade list 105. But user B has no item in his or her wish list 144. The items that user B could potentially receive for items l and m can be identified by finding other users who desire items l and m and have other items to trade for l and m. In the illustrated example, users A, C, and D are members of the same communities as user B (community Gamma). User A desires item l, and is offering to trade in return items i and j. User C also desires item l, and is offering in exchange item o. Similarly, user D desires items m and offers in exchange item n. Thus, the potential trades for user B consists of items i,j from user A, item o from user C, and item m from user D. In the preferred system 10, as shown in screen 200 of FIG. 18A, the potential trades 204 are grouped into their corresponding categories 60 for display purposes. Each potential trade 204 identifies the owner 206 of the potential trade item 208, and provides links 210, 212 to either add the potential trade item 208 to the user's item-for-trade-list 105 or wish list 144. It will be noted that if the given user adds the potential trade item 208 to his or her wish list 144 (as seen in FIG. 18B), the system 10 will thereafter recognize a trade match 176, list it under the matching trade screen 170 (see FIG. 18C), and send out e-mails to the users advising of the match.

Preferably, the number of potential trades shown to the user is filtered or reduced, so as to limit the number of items displayed. The filter may be a user specified criteria such as item category, which can be specified and form part of the user profile. Additionally or alternatively, the system 10 can filter out items or potential matches based on value. For example, a system policy may be employed wherein only other users' items that have values of approximately x % (e.g., 30%) of the value of a given user's item are displayed. In this case, the display screen 200 may be organized on a per item basis, grouping other users' items for each item of the given user. (For example, in screen 200 each of the given user's items may be displayed with a link or a visual grouping of other users' items that may be traded for each particular given user's item.)

The ‘My Messages’ menu choice 62F leads to a web site based private e-mail message service, allowing users to send, receive and view ingoing and outgoing e-mail messages within the context of the web site. In addition to private e-mail, the community pages (such as screen 52, FIG. 4) include community wide message bulletin boards 57 to further social interaction amongst community members.

As a result of the community based aspects of the system 10, including enabling users to designate their own communities and send and receives messages amongst themselves including community wide posts, it is expected that users will “self align” themselves into mutual interest groups and thus increase their social interaction. In addition to increased social interaction, the ability of the system to readily display all potential trades for a given user (and the fact the number of potential trades is limited based on community membership) is also expected to foster bartering amongst community members.

The foregoing detailed description has referred to barterable “items” 58 as physical products. However, it will be understood that the term “item” should be construed broadly to include any service. In the preferred embodiment, various services are segregated into different standard categories (e.g., plumbing, legal, carpentry, gardening) and unitized so that certain services are also standardized. The system also provides a mechanism as described above for including non-standardized services.

In addition, while the invention has been described with reference to the foregoing preferred embodiment thereof, it will be readily apparent to those skilled in the art that the invention is not limited to the disclosed or illustrated embodiments but, on the contrary, is intended to cover numerous other modifications, substitutions, and variations that are included within the spirit and scope of the following claims.

1. An electronic bartering method, comprising:
registering a plurality of persons as users of an electronic bartering system;
associating each user with at least one community and enabling users to create their own communities;
enabling each user to specify at least one barterable item in a wish list and at least one barterable item in a trade list;
within a given community, periodically comparing the wish lists and trade lists only of users within the community in order to identify a trade match;
sending an e-mail message to users advising of the trade match; and
receiving confirmation from the users accepting or rejecting the trade match.

2. A method according to claim 1, wherein a trade match is identified when an item on a first user's wish list appears on a second user's trade list and another item on the second user's wish list appears on the first user's trade list.

3. A method according to claim 2, wherein:
each community is designated as either a private or a public community;
each private community is associated with at least one moderator; and
a user requires permission from at least one moderator of a private community prior to joining the private community.

4. A method according to claim 2, wherein any user can create a new community and the originating user creating the community is the first moderator.

5. A method according to claim 4, wherein any community moderator can pass on moderator rights to any other member of the same community.

6. A method according to claim 2, wherein each community is associated with an electronic bulletin board visible to at least the members of the community.

7. A method according to claim 2, wherein items are associated with a commercial standard product number and a suggested sales price or value.

8. A method according to claim 7, including:
sending a photograph or image of a product bar code to the system;
resolving the bar code to identify the standard product number and corresponding item;
enabling the user to add the corresponding item to the user's wish list or trade list.

9. A method according to claim 8, wherein the system includes an accumulator for estimating the accumulated value of bartered items and wherein, upon acceptance of the trade match, the accumulator is updated.

10. A method according to claim 9, wherein the accumulator is a global accumulator for estimating the value of all trades generated by the system.

11. A method according to claim 9, wherein the accumulator is a community accumulator for estimating the value of all trades within a given community.

12. A method according to claim 9, wherein the accumulator is a personal accumulator for estimating the value of all trades undertaken by a given user.

13. A method according to claim 7, wherein:
a first user can view the trade list or wish list of any second user in any public community or that is a member of the same at least community that the first user is a member of;
each item of the second user's trade list or wish list that is displayed by the system is associated with at least one web link;
the first user can directly incorporate any item on the second user's wish list or trade list into the first user's wish list or trade list by actuating the associated web link.

14. A method according to claim 2, wherein each item is associated with a predetermined item category, and each community is associated with at least one item category.

15. An electronic bartering method, comprising:
registering a plurality of persons as users of an electronic bartering system;
associating each user with at least one community and enabling users to create their own communities;
associating each community with an electronic bulletin board;
enabling each user to specify at least one barterable item in a wish list and at least one barterable item in a trade list;
upon request, (i) comparing a given user's trade list of against the wish lists only of other users that are members of the same communities as the given user in order to identify other users that desire items possessed by the given user, (ii) displaying to the given user at least a portion of the trade lists of said other identified users to thereby identify potential trades for the given user, and (iii) associating each potential trade with a web link which upon actuation incorporates any potential trade item into the given user's wish list;
within a given community, periodically comparing the wish lists and trade lists only of users within the community in order to identify a trade match;
sending a message to users advising of the trade match; and
receiving confirmation from the users accepting or rejecting the trade match;

16. A method according to claim 15, wherein the portion of the trade lists of said other identified users that are displayed to the given user are filtered by user-specified categories.

17. A method according to claim 15, wherein the portion of the trade lists of said other identified users that are displayed to the given user is limited based on relative value of the items in the given user's trade list.

18. A method according to claim 15, wherein a trade match is identified when an item on a first user's wish list appears on a second user's trade list and another item on the second user's wish list appears on the first user's trade list.

19. A method according to claim 18, wherein:
each community is designated as either a private or a public community;
each private community is associated with at least one moderator; and
a user requires permission from at least one moderator of a private community prior to joining the private community.

20. A method according to claim 19, wherein any user can create a new community and the originating user creating the community is the first moderator.

21. A method according to claim 20, wherein any community moderator can pass on moderator rights to any other member of the same community.

22. A method according to claim 18, wherein each community is associated with an electronic bulletin board visible to at least the members of the community.

23. A method according to claim 18, wherein items are associated with a commercial standard product number and a suggested sales price or value.

24. A method according to claim 23, including:
sending a photograph or image of a product bar code to the system;
resolving the bar code to identify the standard product number and corresponding item;
enabling the user to add the corresponding item to the user's wish list or trade list.

25. A method according to claim 23, wherein the system includes an accumulator for estimating the accumulated value of bartered items and wherein, upon acceptance of the trade match, the accumulator is updated.

26. A method according to claim 25, wherein the accumulator is a global accumulator for estimating the value of all trades generated by the system.

27. A method according to claim 25, wherein the accumulator is a community accumulator for estimating the value of all trades within a given community.

28. A method according to claim 25, wherein the accumulator is a personal accumulator for estimating the value of all trades undertaken by a given user.

29. A method according to claim 16, wherein:
a first user can view the trade list or wish list of any second user in any public community or that is a member of the same at least community that the first user is a member of;
each item of the second user's trade list or wish list that is displayed by the system is associated with at least one web link;
the first user can directly incorporate any item on the second user's wish list or trade list into the first user's wish list or trade list by actuating the associated web link.

30. A method according to claim 16, wherein each item is associated with a predetermined item category, and each community is associated with at least one item category.
